(19) United States
(12) Patent Application Publication
(10) Pub. No.: US 2004/0007649 A1
(43) Pub. Date: Jan. 15, 2004

(54) Stand for portable computer

(76) Inventor: Mark A. Vettraino, Woodstock, GA (US)

Correspondence Address: GILBRETH & ASSOCIATES, P.C., P.O. Box 2428, Bellaire, TX, 77402-2428, US

(21) Appl. No.: 10/414,426

(22) Filed: Apr. 15, 2003

Related U.S. Application Data
(60) Provisional application No. 60/372,857, filed on Apr. 15, 2002.

(51) Int. Cl. F16M 11/00

(52) U.S. Cl. 248/127; 248/454

(57) ABSTRACT

A stand for a portable computer, including a base member to which is pivotably attached the computer holding member. An adjustment arm serves to fix the relative position of the base member and the computer holding member.

### RELATED APPLICATION DATA

This application claims priority from U.S. Provisional Patent Application No. 60/372,857, filed Apr. 15, 2002.

### BACKGROUND OF THE INVENTION

1. Field of the Invention

The present invention relates to computers. In another aspect, the present invention relates to portable computers, more specifically those known as laptop or notebook computers. In even another aspect, the present invention relates to apparatus for use with portable computers, to methods of making and using such apparatus, to a portable computer system, and to methods of operating portable computers. In still another aspect, the present invention relates to a support stand for portable computers, to methods of making and using such a stand, to a portable computer system including the computer and stand, and to a method of operating the portable computer.

2. Description of the Related Art

There are a number of patents directed to stands for portable computers.

U.S. Pat. No. 6,115,249 describes a portable computer stand for enhanced cooling. Portable personal computers, as with all computers, have faced the issue of thermal management as a result of heat generated by the processor and other components of the computer. The invention purportedly enhances the performance of a portable personal computer by allowing it to operate in two different states, one where heat dissipation is higher than the other. The higher heat dissipation state is made possible by providing a stand that nests into the base or bottom cover of the computer. The stand includes a base having a front side, a back side, a right side, a left side, and a bottom surface. The stand includes at least one stand member interconnectable with the base. The stand member is positionable in a deployed position and a stowed position. When the stand is in a deployed position, it permits greater heat dissipation from the computer by allowing ambient air to circulate under and behind the computer.

U.S. Pat. No. 6,208,508B1 discloses a space-saving docking station for vertically supporting an opened notebook computer. The docking station includes a generally wedge-shaped expansion base to a front side of which the computer base housing may be electrically coupled to connect the notebook computer to desktop peripheral devices such as a keyboard and mouse, and a stand structure for supporting the expansion base, and thus the docked computer, in the space-saving vertical orientation in which the exposed notebook computer display screen is elevated relative to the desktop area may be utilized in conjunction with the desktop keyboard and mouse.

U.S. Pat. No. 6,229,698B1 describes a compact, light-weight portable office having a computer workstation that can be transported from place to place within and removed from an impact resistant carrying case. The carrying case is provided with a shock isolation system to absorb shock and dampen low frequency vibrations whereby to reduce the risk of damage to the workstation during shipment and enable the workstation to be used in a moving motor vehicle. In an as-packaged configuration, the computer workstation is detachably connected to a flat table surface that extends across the carrying case. In a detached configuration, the computer workstation is lifted off the table surface and separated from the carrying case to be transported to a remote worksite outside the confines of the carrying case.

U.S. Pat. No. 6,234,085B1 relates to a portable laptop workstation that is expandable to span the distance of an individual's lap to provide a comfortable, flat surface area designed to accommodate a laptop computer and a variety of small computer related accessories. When expanded, two flat, rigid members span the distance across the user's lap to provide a comfortable, flat surface designed primarily to accommodate the use of a laptop computer. After use, the extended plate members can be retracted by simply sliding the two members of the tray together. Then the tray can be stored and toted, usually in the same case or valise as the laptop computer.

U.S. Pat. No. 6,260,486B1 discloses a stand for supporting and securing an item such as a portable computer and comprises a hinged leaf assembly with adjustably positionable clamping members. The clamping members are slidingly secured along outer edges of hingedly connected leaves of the leaf assembly to permit sliding advancement of the clamping members relative to and along the edges of the leaves to which they are attached. An articulated arm is secured at an upper end to the underside of the leaf assembly and at a lower end to the surface relative to which the item is to be supported such as the floor of a vehicle.

U.S. Pat. No. 6,273,310B1 describes a laptop computer workstation accessory for an automobile. The workstation includes a portable case adapted to be transported manually by the driver and placed in an automobile intermediate the driver seat and the passenger seat. The case includes a lower portion with a pivotal laptop computer support structure on which to mount a laptop computer with hook-and-loop fabric fastener, and a lockable upper portion pivotally connected to the lower portion for movement between a closed position in which the upper portion covers the laptop computer support structure and an open position in which it exposes the laptop computer support structure to the driver. The upper portion is adapted to hold a pad of writing paper and the lower portion includes a moveable printer support structure behind a moveable side panel on the passenger side.

U.S. Pat. No. 6,352,233B1 illustrates a portable stand that allows a user to position a laptop computer as well as a full size external keyboard substantially vertically relative to a support surface. The substantially vertical positioning provides improvements to the laptop work environment. The portable stand includes two generally flat bodies that are attached together along a mating groove. The two flat bodies define a substantially U-shaped area to hold the laptop computer in a substantially vertical position, a groove to hold an external keyboard in a substantially vertical position for storage, and an area for cables and wires to be consolidated and held in position.

PCT/US98/08564 pertains to an adjustable mobile platform (94), typically for supporting a laptop computer. The essential features of the invention are its ability to be adjusted to a particular location and then be useable on a day to day basis without having to be readjusted. It can be folded up and placed in the middle of the car between the driver and passenger and it can easily be removed and stored behind the seat. The invention can be mounted within a wide variety of cars, vehicles and other modes of transportation.

PCT/US99/27989 discloses a lightweight and inexpensive portable desk (10) useful as a support for an article, a book, a magazine, a laptop computer, a drawing, a photograph, a painting, writing utensils, and the like. The portable desk comprises just two integral components, a desk member (12) and a leg member (14). Some purported unique features of the portable desk include: 1) a capacity to vary the tilt angle according to the needs of a particular user and work setting and 2) the leg member serves as a base to support the desk member and includes a projection (56) that allows for efficient storage/transportation of the portable desk. Thus, the portable desk provides several working configurations at various inclinations and can be assembled in a securely connected compact storage/transportation configuration.

PCT/US00/01310 relates to a device (12) for conveniently supporting a laptop computer (10) on the lap of the user thereof, and more particularly to such a device (12) which is substantially universally adjustable for supporting the computer (10) in a preferred and optimal position for use. In its broadest aspects, the invention is directed to a portable, adjustable laptop (notebook) computer support (12). The invention can also be used to support other portable data devices that have keyboards, such as pen-input-type computers and personal, electronic data organizers. The device comprises three or more hinged panels (20, 28, 32) which can be selectively folded and secured relative to one another in a preferred operational configuration.

PCT/US00/33628 describes a collapsible computer platform assembly for use with a notebook or portable computer, wherein the computer platform assembly comprises a platform having a first surface and an opposite second surface, and a support arm assembly for supporting the bottom surface of a computer. The support arm assembly comprises at least one base portion extending from the second surface of the platform and at least one adjustable arm assembly connected to the at least one base portion. The invention also includes within its scope a platform assembly that is slideably connected to the base portion. The adjustable arm assembly may be rotatable relative to the platform. The platform assembly may also include a mousing surface or a wrist rest pad on its first surface. It is further understood that the support arm assembly may further comprise at least one leg extending from at least one of the adjustable arm assembly and the base portion. Also provided is a method of supporting a portable computer relative to the surface on which the computer is placed with a computer platform assembly of the type described above.

However, in spite of the above advancements, there still exists a need in the art for a stand for portable computers.

There is another need in the art for a stand for portable computers which do not suffer from the disadvantages of the prior art apparatus and methods.

These and other needs in the art will become apparent to those of skill in the art upon review of this specification, including its drawings and claims.

### SUMMARY OF THE INVENTION

It is an object of the present invention to provide for a support stand for portable computers, to methods of making and using such a stand, to a portable computer system including the computer and stand, and to a method of operating the portable computer.

These and other objects of the present invention will become apparent to those of skill in the art upon review of this specification, including its drawings and claims.

### BRIEF DESCRIPTION OF THE DRAWINGS

FIG. 1 is an isometric view showing one embodiment of stand 100 of the present invention comprising base support member 101 to which is pivotally attached computer holding member 103.

FIG. 2 is a top of an another embodiment of stand 100 of the present invention, again showing base support member 101 to which is pivotally attached computer holding member 103.

FIG. 3 is a side view of stand 100 of FIG. 2, showing base support member 101 to which is pivotally attached computer holding member 103.

FIG. 4 is a top view of one embodiment of base support member 101 of FIGS. 2 and 3.

FIG. 5 is a side view of one embodiment of base support member 101 of FIGS. 2, 3 and 4.

FIG. 6 is a top view of computer holding member 103 of FIGS. 2 and 3.

FIG. 7 is a side view of computer holding member 103 of FIGS. 2, 3 and 7.

FIG. 8 is a top view of stand 100 showing optional cover 160 provided to protect wrist support 151.

FIG. 9 is a side view of stand 100 showing optional cover 160 provided to protect wrist support 151.

FIG. 10 is a top view of stand 100 showing adjustment arm 104.

FIG. 11 is a side view of stand 100 showing adjustment arm 104.

FIG. 12 is a top view of a further embodiment of stand 100 of the present invention showing a carrying handle 165 to be grasped by a user's hand, with the user's fingers fitting into hand slot 167 defined by holding member 103.

FIGS. 13-22, FIGS. 23A, 23B, 23C, FIGS. 24-29, FIGS. 30A, 30B, and FIG. 31, are all views of the various embodiments of the present invention.

### DETAILED DESCRIPTION OF THE INVENTION

The stand of the present invention includes a base support member which is pivotally attached to a computer support member. The relative position of the base support member and the computer support member is maintained by an adjustment arm.

A computer system of the present invention includes a portable computer and the stand of the present invention. The computer and the stand may be permanently attached, or may be removably attached.

A method of operating a portable computer includes positioning the computer at a desired angle by adjustment of the stand's adjustment arm.

The present invention will now be described by reference to the figures, in which like numbers between figures refer to like elements.

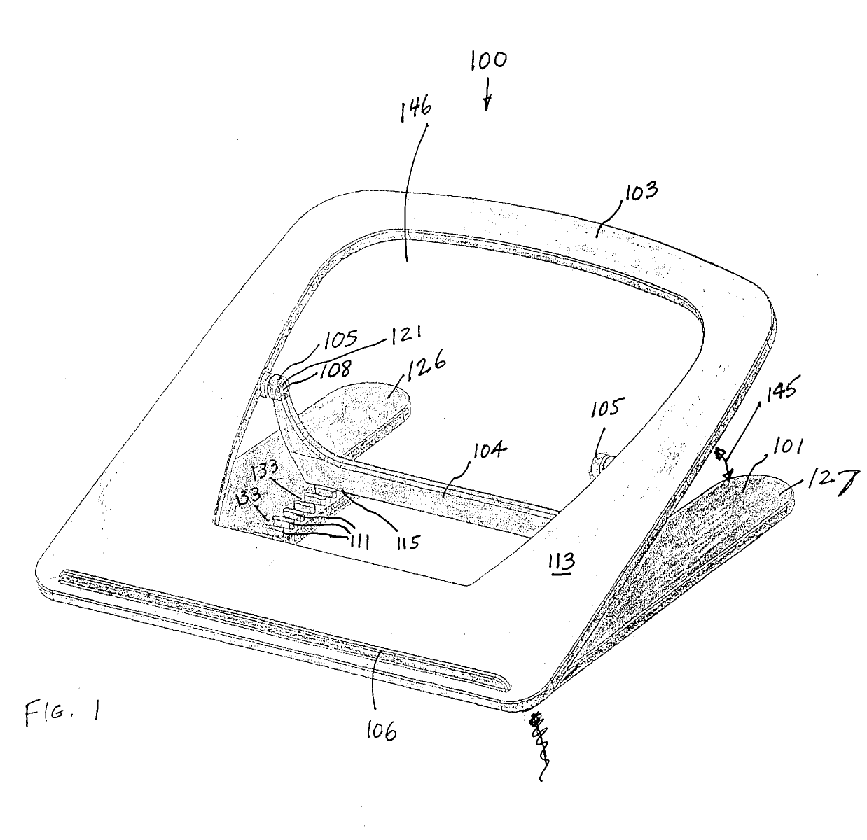

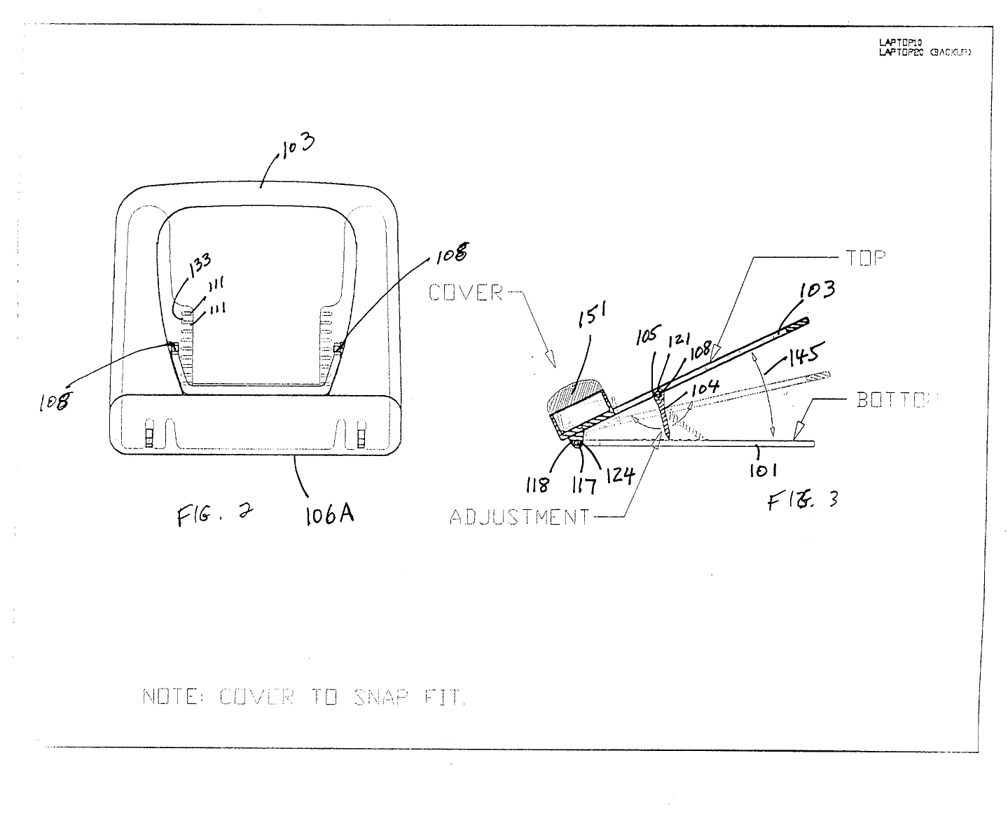

Referring now to FIG. 1, there is shown one embodiment of stand 100 of the present invention comprising base support member 101 to which is pivotally attached computer holding member 103. Referring additionally to FIGS. 2 and 3, there are shown top and side views, respectively, of another embodiment of stand 100 of the present invention, again showing base support member 101 to which is pivotally attached computer holding member 103.

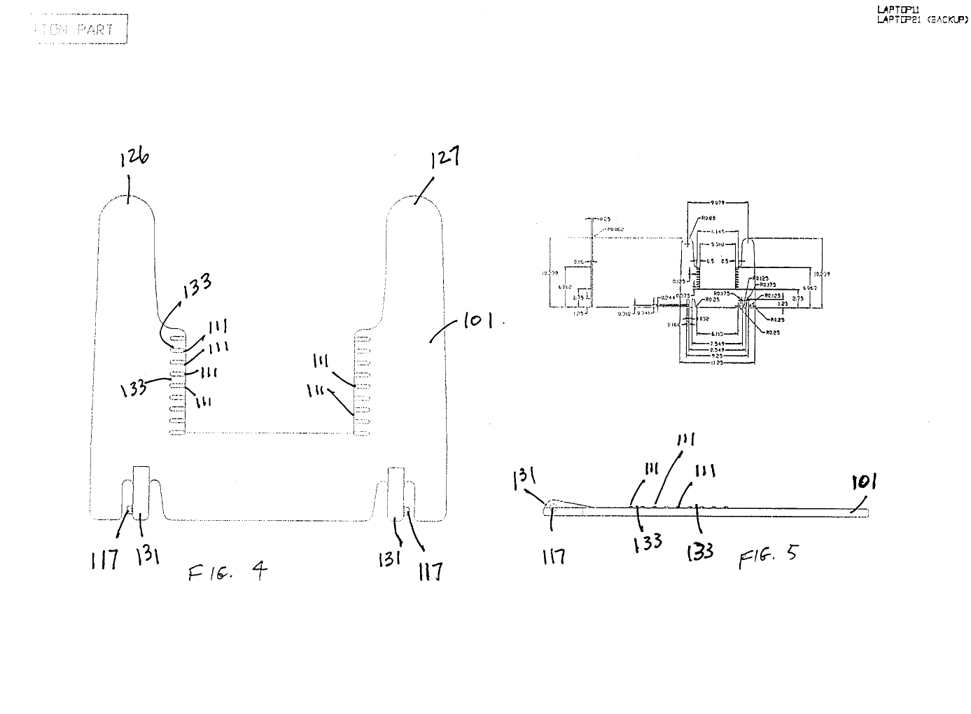

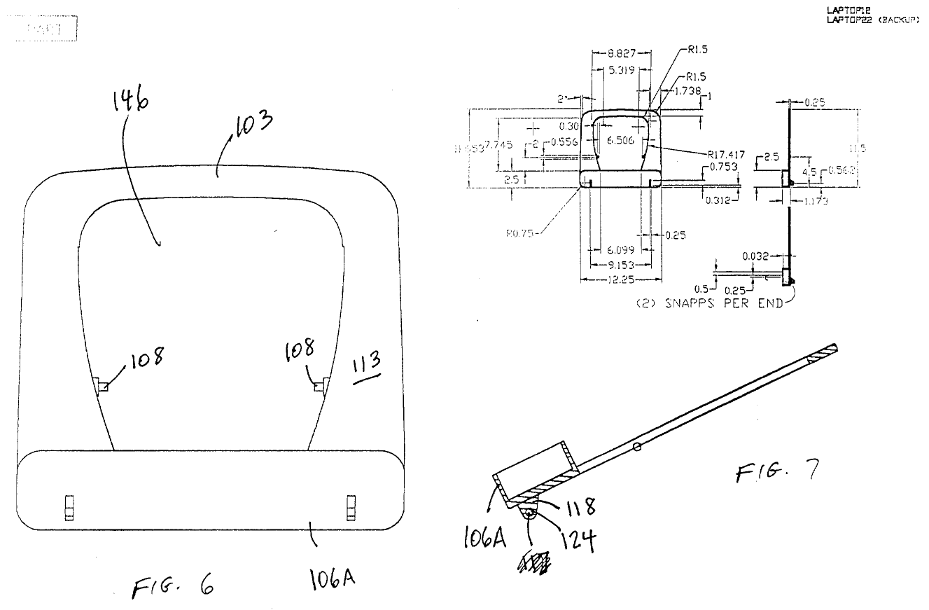

Referring additionally to FIGS. 4 and 5, there are shown top and side views, respectively, of base support member 101. As shown, a number of retaining members 111 serve to define between adjacent retaining members 111 a number of slots 133. Angle adjustment arm 104 may be positioned in any of the slots 133 to effect angle 145 between base support member 101 and computer holding member 103. Alternatively, base support member 101 may be provided with a number of grooves for receiving adjustment arm 104. Base support member 101 further includes pivot supports 131 from which extend pivot pins 117.

In the present invention, base support member 101 is generally suitable to provide stable support for stand 100. Generally, stable support will be provided by having a sufficient width and depth for base support member 101. A trade-off will generally be made between sufficient width and depth for stable support and to minimizing the “footprint” that base support member 100 will make on a surface. In the embodiment shown in FIG. 1, base support member 101 comprises legs 126 and 127 spaced sufficiently apart to provide adequate support and stability.

To provide stand 100 with some amount of resistance to lateral movement while on a work surface, part or all of the bottom of base support member 101 which comes into contact with a work surface, will comprise skid resistant material.

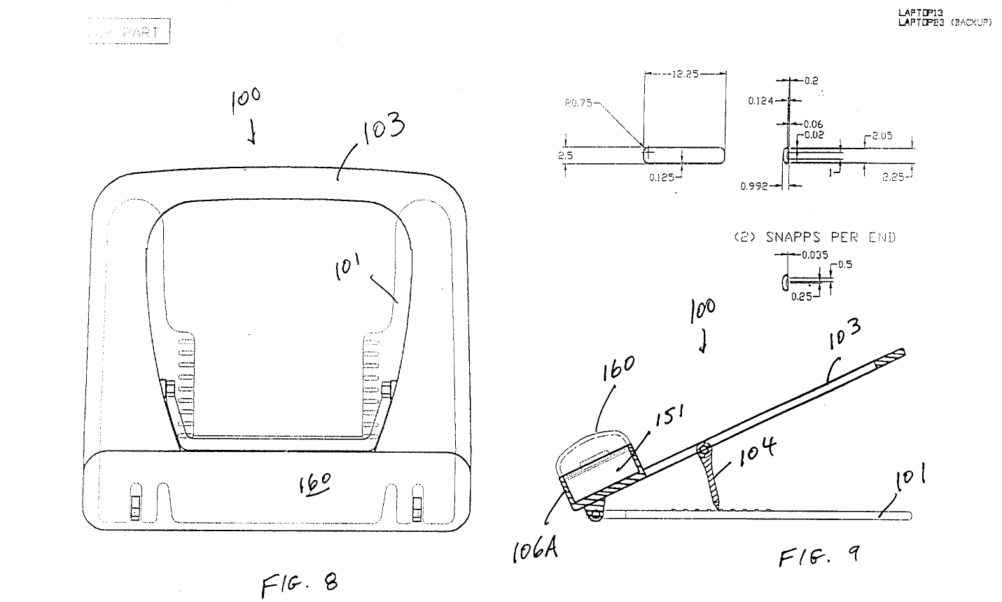

Referring additionally to FIGS. 6 and 7, there are shown top and side views, respectively, of computer holding member 103. Generally, computer holding member 103 must present a sufficient surface 113 to hold the desired portable computer. To reduce weight and material costs, computer holding member 103 will generally define one or more hollow zones 146. For example, as an alternative embodiment, computer holding member 103 could comprise a number of smaller hollow zones 146. As a further alternative embodiment, computer holding member 103 could be in an ornamental or decorative shape (for example, a corporate logo). As even a further alternative embodiment, computer holding member 103 could comprise one or more hollow zones 146, which zones form an ornamental or decorative design or pattern.

Computer holding member 103 further includes pivot pins 108 on which angle adjustment arm 104 is pivotally attached.

Computer holding member 103 even further includes pivot passage supports 118 which define passages 124. The pivot pins 117 of base support member 101 are rotatably positioned in passages 124 allowing computer holding member 103 and base support member 101 to pivot relative to each other.

In the embodiment as shown in FIG. 1, computer holding member is provided with a support ledge 106 on surface 113. This support ledge 106 may be used to support a wrist support, that is, a cushioned support (i.e, foam, rubber, cushioned fabric, gel-filled material, and the like) to provide a comfortable support for the user's wrists. A portable computer is then laid upon surface 113 and supported by the wrist support. Alternatively, in the absence of a wrist support, the portable computer may be laid upon surface 113 and directly supported by support ledge 106.

This wrist support will be supported by ledge 106 and may be further affixed to surface 113 by means of adhesive or by a mating connection between the surface and the wrist support (for example, hook and loop fastener system such as the commercially available VELCRO®).

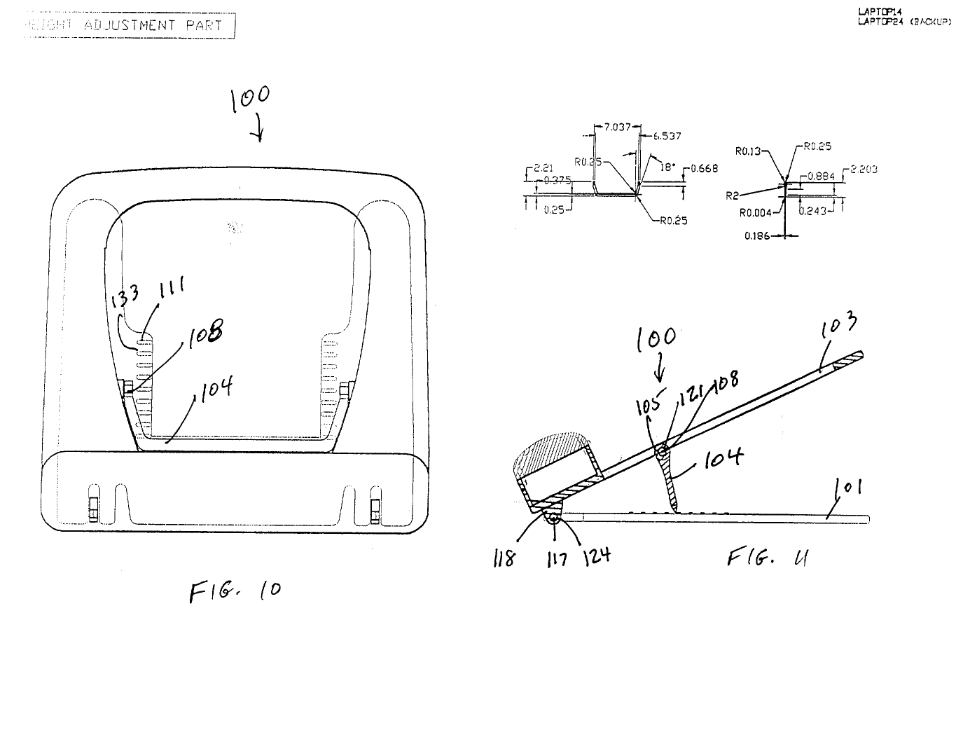

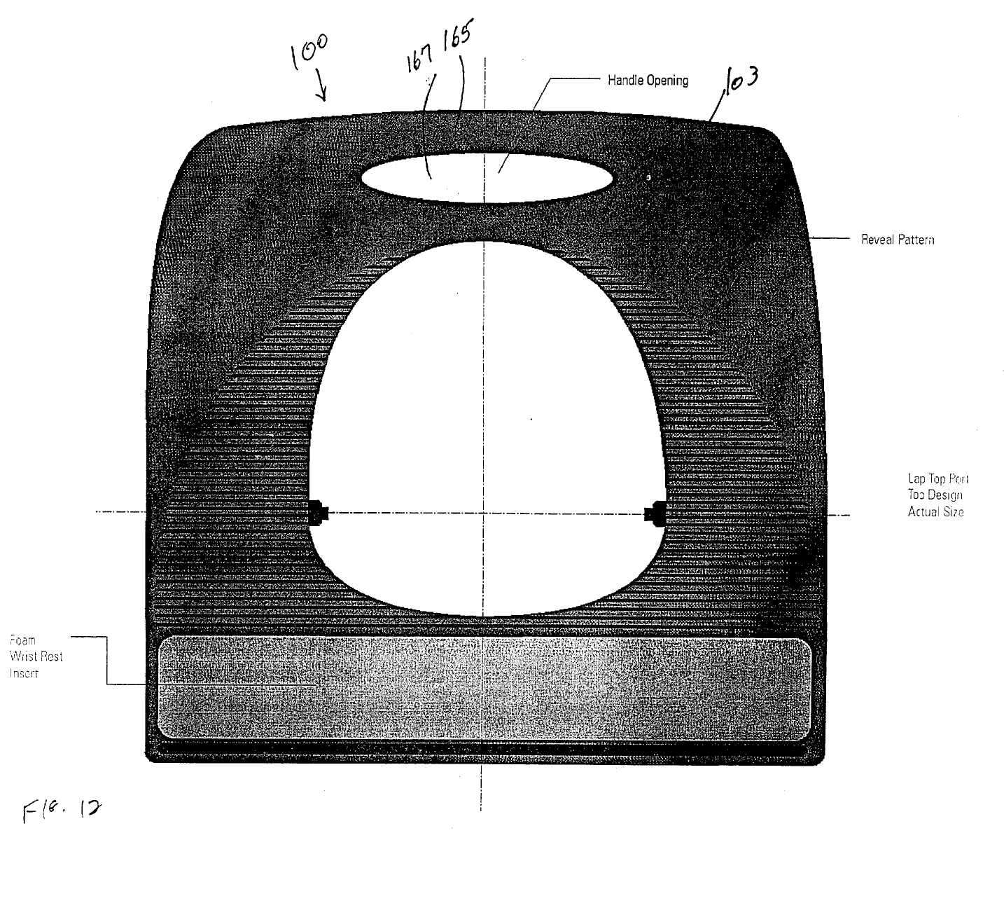

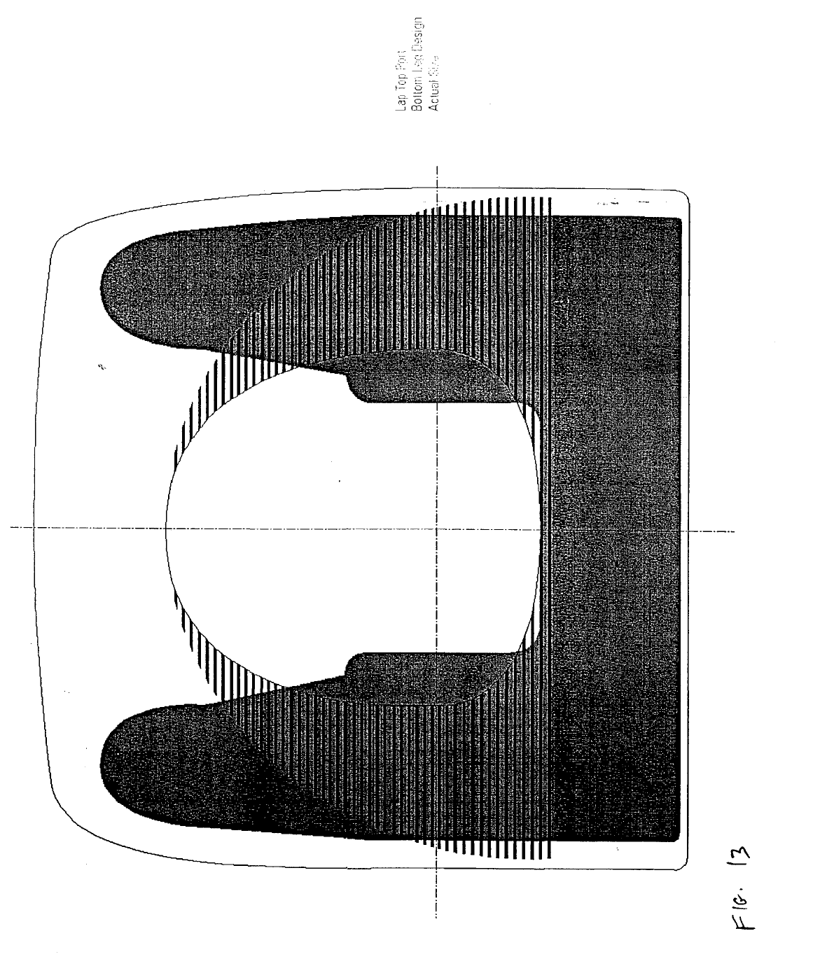

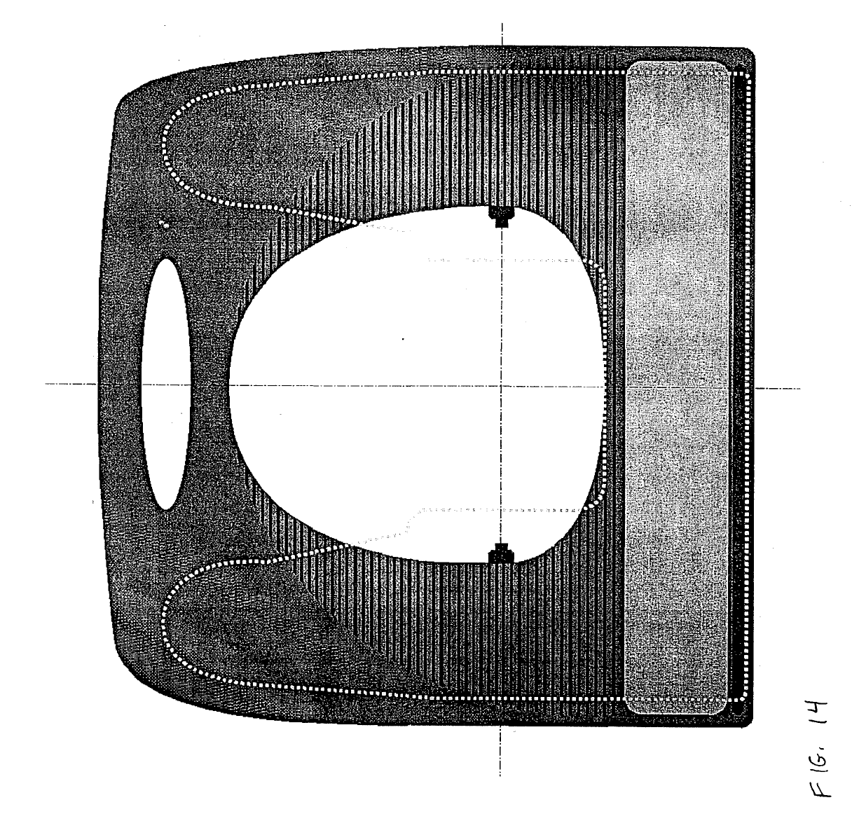

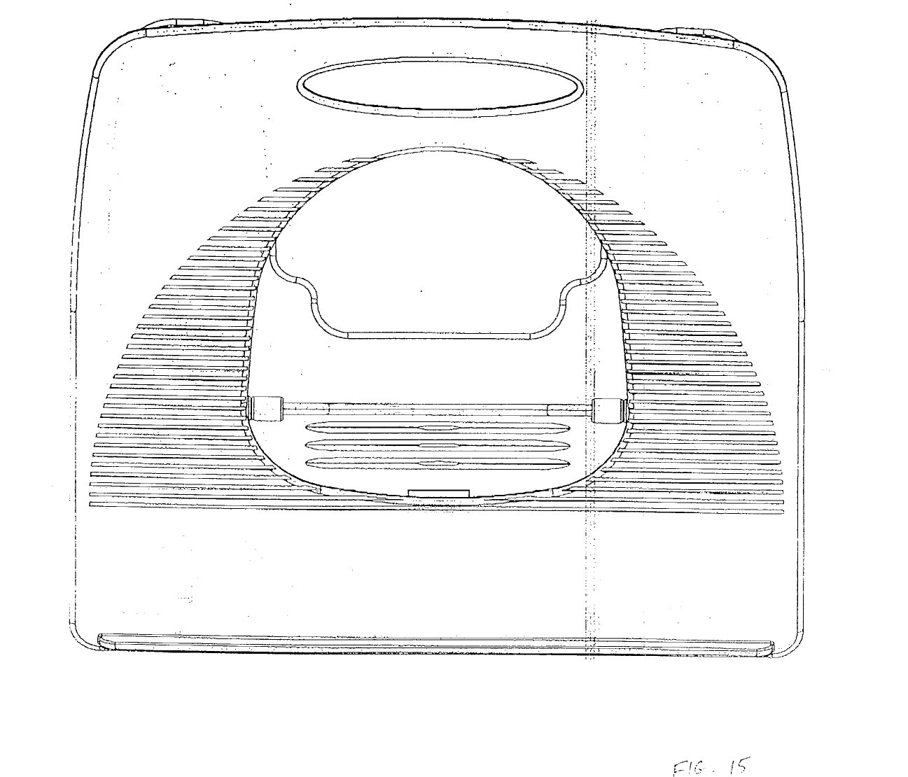

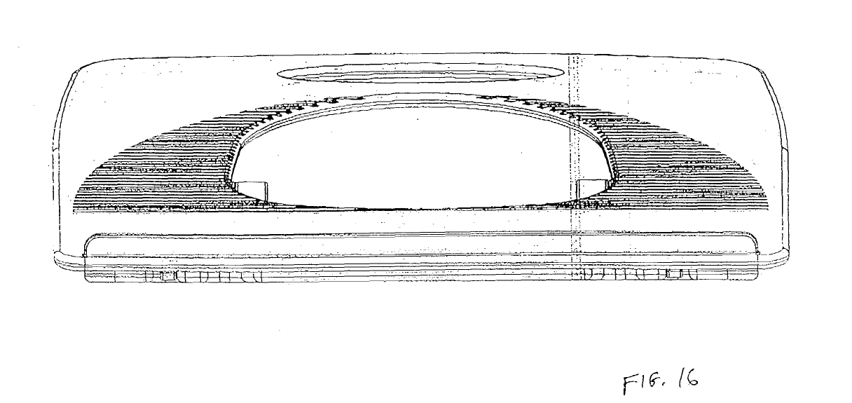

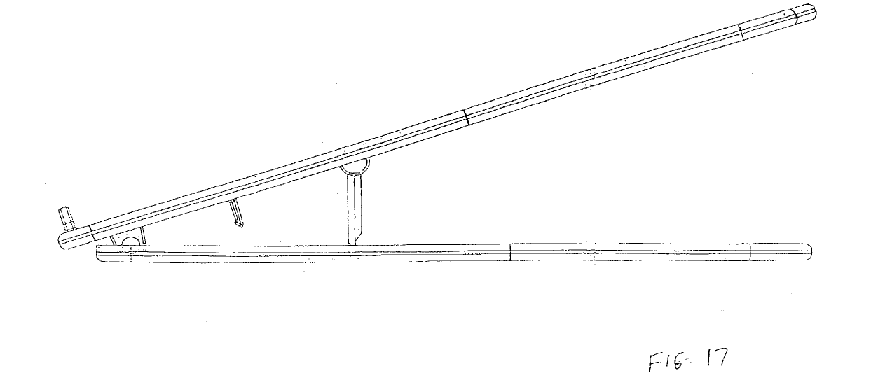

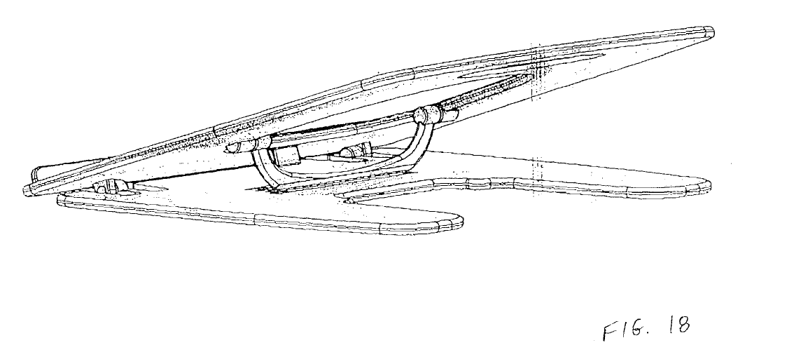

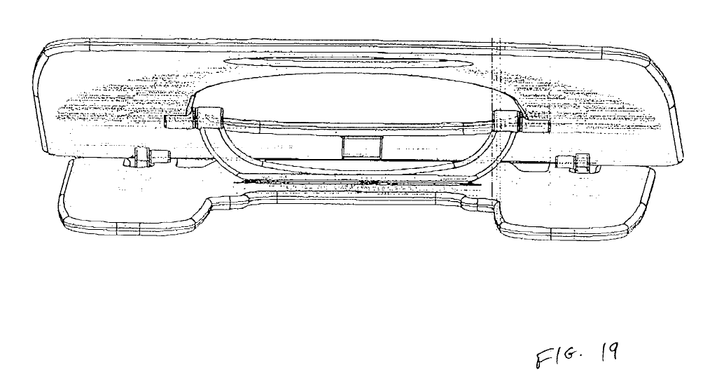

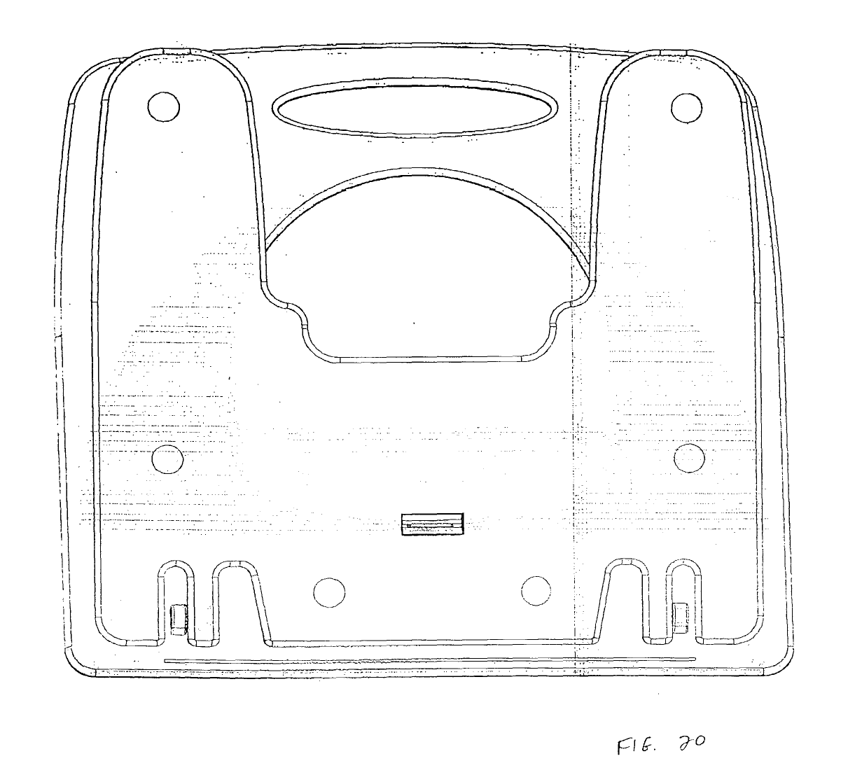

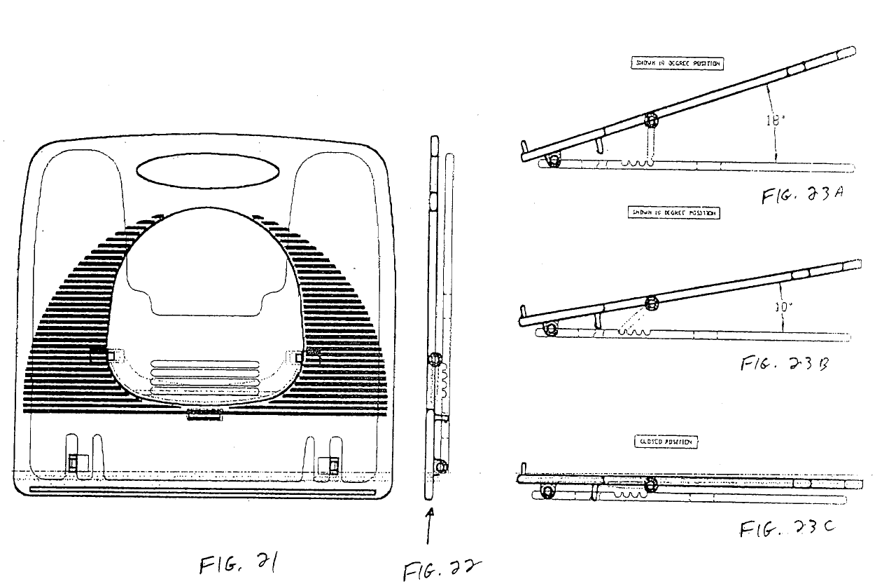

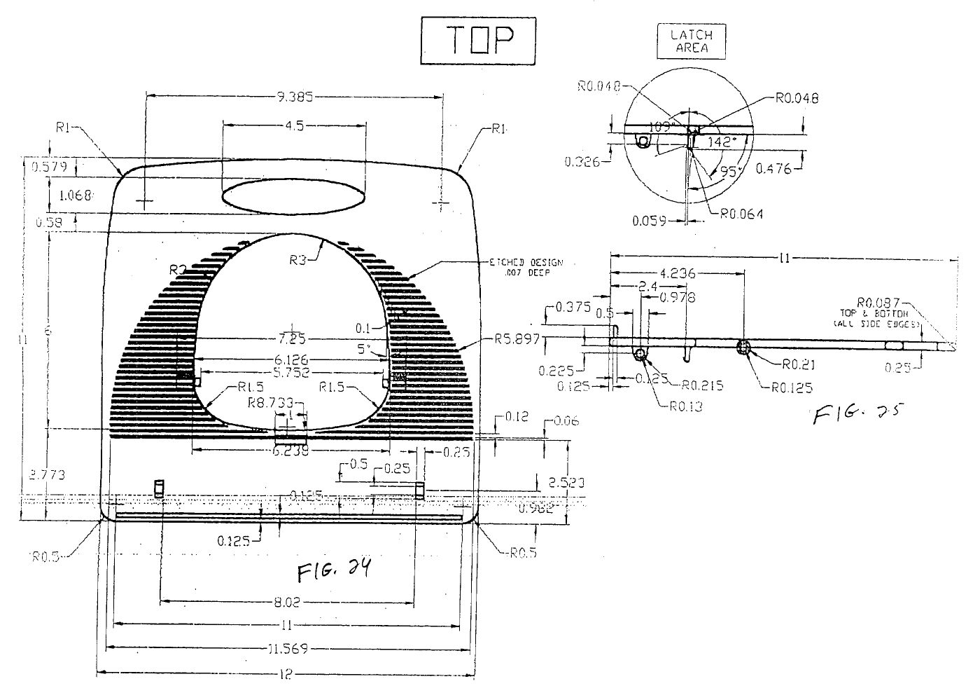

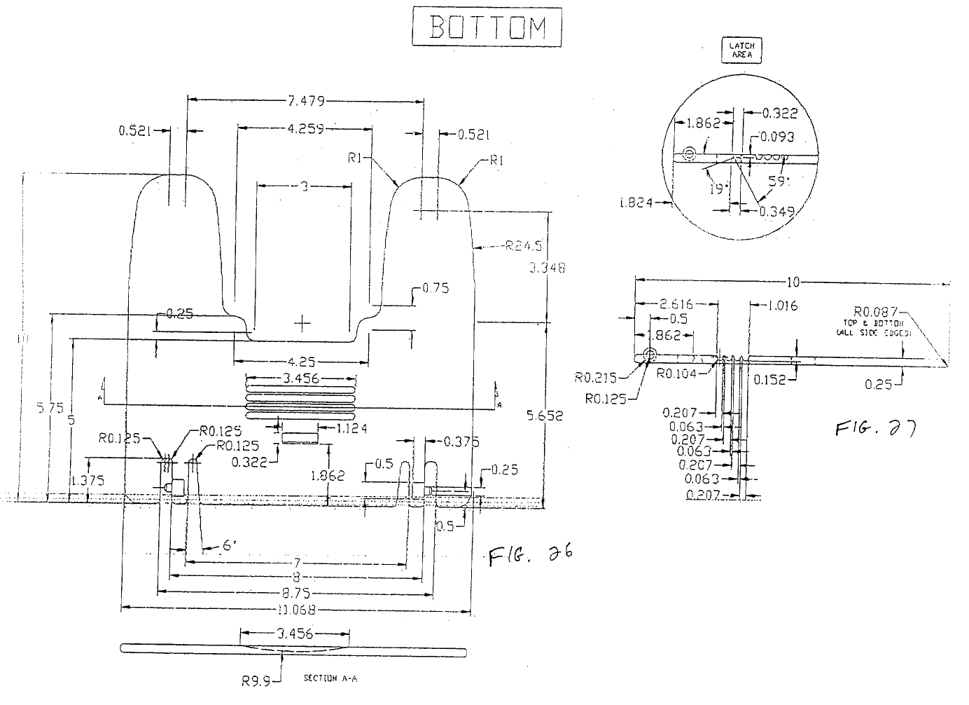

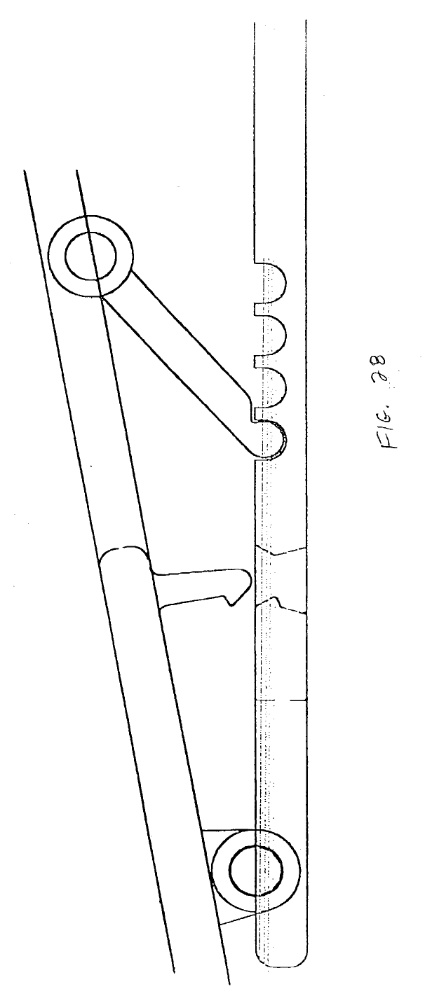

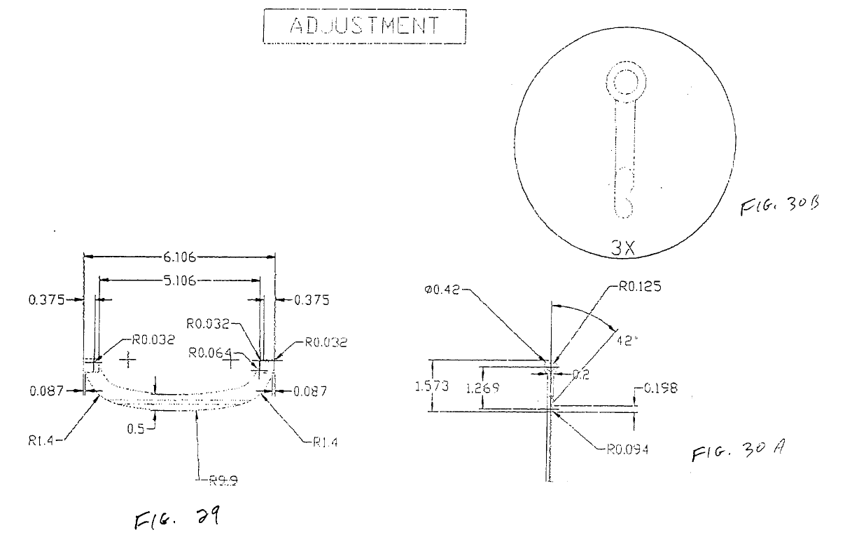

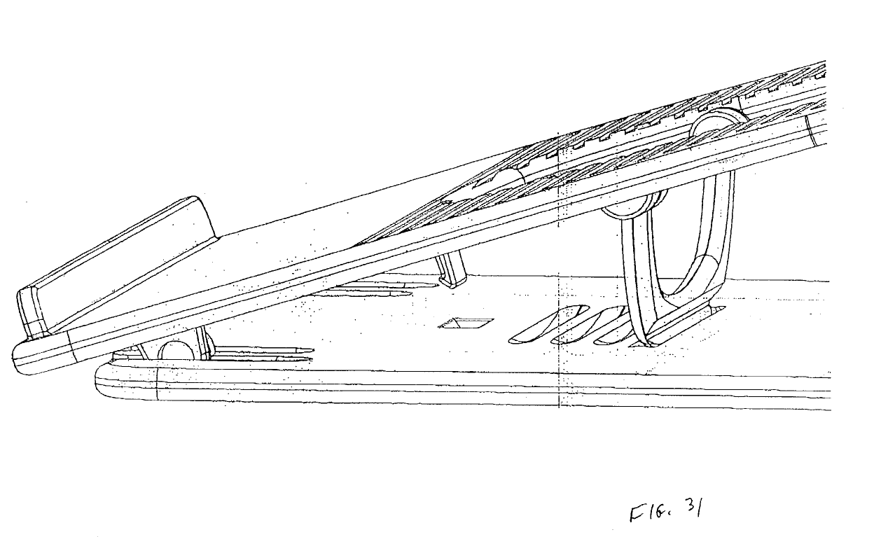

In the embodiment as shown in FIGS. 2, 3, 6 and 7, computer holding member is provided with a support tray 106A on surface 113 in which wrist support 151 is positioned to provide a comfortable support for the user's wrists. A portable computer is then laid upon surface 113 and supported by this tray 106A. An optional cover 160, as shown in FIGS. 8 and 9, may be provided to protect wrist support 151, when stand 100 is not in use.

Referring additionally to FIGS. 10 and 11, there are shown top and side views of stand 100 showing adjustment arm 104. Adjustment arm 104 includes pivot guides 105 which define pivot passages 108, into which computer holding member pivot pins 108 are positioned. Adjustment arm 104 is pivotally movable around pivot pins 108. Adjustment arm edge 115 is then positionable in the various slots 133 to adjust the relative angle 145 between computer holding member 103 and base support member 101.

Surface 113 may be scored or otherwise provided with a skid resistant surface to resist movement of the portable notebook computer. Alternatively, computer holding member 103 may be provided with a fastener system to secure a portable notebook computer. As a non-limiting example, the portable notebook computer and computer holding member 103 may be provided with mating fasteners, for example, a post on holding member 103 friction fitting into a slot on the notebook computer. As another non-limiting example, the portable notebook computer and computer holding member 103 may be provided with a hook and loop fastener system such as the commercially available VELCRO@. As even another limiting example, stand 100 may be incorporated into the portable notebook computer.

Referring additionally to FIG. 12, there is shown a further embodiment of stand 100 of the present invention showing a carrying handle 165. A user's hand will grasp handle 165, with the user's fingers fitting into hand slot 167 defined by holding member 103.

To prevent computer holding member 103 and base support member 101 from pivoting relative to each other during storage or during transportation, a lock or fastening mechanism may be provided. As non-limiting examples, a lock or clasp, or one member may be provided with a post that friction fits into a slot in the other member.

The materials of construction for the stand of the present invention will generally be selected taking into account engineering and economic considerations. Non-limiting examples of suitable materials of construction include natural and made-made materials, including plastics (both thermoset and thermoplastic), metals, ceramics, wood. Of course, it should be understood that the stand of the present invention may comprise more than one material. Preferably, the stand of the present invention is made of a plastic, more preferably a polyolefin such as polypropylene.

Manufacture of the present invention will be carried out using techniques as are known in the manufacturing art. As a non-limiting example, assuming a material of construction of plastic, a suitable method of manufacture would include injection molding.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A computer stand apparatus comprising:
(A) a computer holding member comprising a surface onto which a computer is positioned;
(B) a base member hinged to the computer holding member;
(C) an arm positioned to support the computer holding member in a hinged position above the base member.

2. The apparatus of claim 1, wherein the arm has a first end pivotally affixed to either the computer holding member or the base member, and a second end movably affixed to whichever of the computer holding member or the base member that the first end is not attached.

3. The apparatus of claim 2, wherein the arm is movably affixed along various points to vary a relative angle formed by the computer holding member and the base member.

4. The apparatus of claim 1, wherein the computer holding member surface comprises a holder for securing a computer on the surface.

5. The apparatus of claim 4, wherein the holder comprises a ledge on which the computer rests.

6. The apparatus of claim 4, wherein the holder comprises a skid resistant material on which the computer rests.

7. The apparatus of claim 4, wherein the holder comprises one half of a locking mechanism which mates with an other half of a locking mechanism connected to the computer rests.

8. A computer system apparatus comprising:
(A) a computer;
(B) a computer holding member comprising a surface onto which the computer is positioned;
(C) a base member hinged to the computer holding member;
(C) an arm positioned to support the computer holding member in a hinged position above the base member.

9. The apparatus of claim 8, wherein the arm has a first end pivotally affixed to either the computer holding member or the base member, and a second end movably affixed to whichever of the computer holding member or the base member that the first end is not attached.

10. The apparatus of claim 8, wherein the arm is movably affixed along various points to vary a relative angle formed by the computer holding member and the base member.

11. The apparatus of claim 8, wherein the computer holding member surface comprises a holder for securing the computer on the surface.

12. The apparatus of claim 8, wherein the holder comprises a skid resistant material on which the computer rests.

13. The apparatus of claim 8, wherein the holder comprises one half of a locking mechanism which mates with an other half of a locking mechanism connected to the computer rests.

14. A method of securing a computer, the method comprising;
(A) positioning a computer on a computer holding member, wherein the computer holding member is hinged to a base member, and wherein an arm is positioned to support the computer holding member in a hinged position above the base member.

15. The method of claim 14, further comprising:
adjusting the arm to adjust a relative angle formed by the computer holding member and the base member.
